(19) United States
(12) Patent Application Publication
(10) Pub. No.: US 2012/0135876 A1
(43) Pub. Date: May 31, 2012

(54) HIGH-THROUGHPUT ASSAY METHODS AND ARTICLES

(75) Inventors: Sergey V. ROZHOK, Skokie, IL (US); Yong Jie OUYANG, Chicago, IL (US)

(73) Assignee: Nanolnk, Inc.

(21) Appl. No.: 13/286,092

(22) Filed: Oct. 31, 2011

Related U.S. Application Data
(60) Provisional application No. 61/409,062, filed on Nov. 1, 2010.

(51) Int. Cl. C40B 30/04; C40B 40/10

(52) U.S. Cl. 506/9; 506/18

(57) ABSTRACT

An assay device and method of use thereof, include a multiwell chip and a microarray slide printed with capture molecules. The chip contains shallow wells for holding liquid samples and, optionally, shoulders for receiving the slide. The slide, when placed on the chip, can contact the top of the liquid sample and draw the liquid sample upwards onto the capture molecules. The microarray slide and multiwell chip are capable of forming a closed incubation chamber preventing outside contamination and liquid evaporation. Patterning of the slide can be carried out by direct write lithography or nanolithography, including DPN printing. Small liquid volumes can be used.

### RELATED APPLICATIONS

This application claims priority to U.S. provisional application Ser. No. 61/409,062 filed Nov. 1, 2010, which is hereby incorporated by reference in its entirety.

### BACKGROUND

To meet the challenges of the new genomics and proteomic applications, it is required to achieve sensitive and efficient analysis of large numbers of interactions in parallel. High-density microarrays are ideally suited for parallel multiplex screening of thousands of interactions with minimum use of materials. Most (if not all) technologies allowing detection and screening multiple biological analytes in vitro use a solid phase platform like glass slides, membranes, microliter wells, mass spectrometer plates, beads, or other particles in order to build arrays of multiple sites for capturing target molecules from solution.

The prior art glass slide platforms for running biological (protein) assay are typically limited to 16 or 24 microarrays per slide. Some groups have demonstrated developments in which 48- or 96-well arrays on a structured single glass slide were printed and hybridized with one sample per array. See Huang et al., Clinical Chemistry, 47(10):1912-1916 (2001).

Development of microarray printing technology allows the simultaneously parallel printing of molecules on a small area, which allows the measurement of considerable number of molecular interactions in a single experiment. However, to achieve all benefits of high throughput printing and running assays on a micron scale, it is necessary to provide access of reagents to an extremely small areas with no cross contamination to surrounding. Typical format of running assay on a glass slide is using specific gasket(s) that localize each array to a single reaction well. However, gaskets generally are not able to conform to very well to small wells due to strong surface tension of liquid reagents to the gasket material that prevents them from reaching the glass surface. An example of a gasket device is shown in FIG. 13.

### SUMMARY

Embodiments described herein include, for example, methods of making, methods of using, kits, and devices.

One embodiment provides a method comprising providing a chip comprising a top surface, edges surrounding the top surface, a plurality of wells of a first volume on the top surface, and, optionally, shoulders along the edges and elevated from the top surface; providing a slide comprising a bottom surface and at least one reactive site on the bottom surface; administering at least one liquid sample of a second volume into at least one of the wells, wherein the second volume substantially exceeds the first volume, and wherein the liquid sample sits within and above the well; placing the slide over the chip such that the reactive site is positioned above at least one of the wells and contacts the liquid sample.

In one embodiment, the shoulder is not optional but present, and the placing of the slide results in the slide contacting the shoulder.

In one embodiment, the optional shoulder is not present.

In one embodiment, the chip is made of plastic.

In one embodiment, the number of wells is at least 24.

In one embodiment, the number of wells is at least 96.

In one embodiment, the wells are disposed on the top surface in a regular array layout.

In one embodiment, the distance between the wells matches the pitch between the tips of commercially available multichannel pipettes or liquid handling systems.

In one embodiment, the distance between neighboring wells is about 2.5 mm to about 9 mm.

In one embodiment, the well is of round shape.

In one embodiment, a plurality of wells are present and of more than one shape.

In one embodiment, the wells of the chip are formed from a patterned layer formed on a substrate.

In one embodiment, the depth of the well is about 25 microns to about 500 microns.

In one embodiment, the depth of the well is about 100 microns to about 250 microns.

In one embodiment, the depth of the well is about 140 microns to about 180 microns.

In one embodiment, the first volume is less than 2.5 ul.

In one embodiment, the first volume is less than 1 ul.

In one embodiment, the shoulder is present and the height of the shoulder is about one mm or less.

In one embodiment, the shoulder is present and the height of the shoulder is about 650 microns or less.

In one embodiment, the liquid sample is administered manually through multichannel pipettes.

In one embodiment, the liquid sample is administered through an automated liquid handling system.

In one embodiment, the second volume is about 0.5 microliters to about 25 microliters.

In one embodiment, the liquid sample sits in the well in a hemisphere shape.

In one embodiment, the shoulder is present, and the distance from the bottom of the well to the top of the liquid sample sitting in the well exceeds the depth of the well plus the height of the shoulder.

In one embodiment, the liquid sample comprises analytes capable of being captured by the reactive site.

In one embodiment, the liquid sample comprises antigens and wherein the reactive sites comprises antibodies.

In one embodiment, the slide is made of glass.

In one embodiment, the slide is a solid piece of epoxy glass.

In one embodiment, the slide is a solid piece of epoxy glass printed with an array of antibodies for reactive sites.

In one embodiment, the reaction site is printed onto the slide via a direct write nanolithography process, such as, for example, a Dip Pen Nanolithography process.

In one embodiment, the reaction site is printed with use of direct write nanolithography.

In one embodiment, the reaction site is printed with use of a stamping process or a non-contact printing process.

In one embodiment, the positions of the reaction site matches the positions of the wells.

In one embodiment, the reaction site comprises at least one capture molecule capable of capturing analytes.

In one embodiment, the bottom surface of the slide is hydrophilic.

In one embodiment, the liquid sample transforms to a cylindrical shape upon contacting the bottom surface of the slide.

In one embodiment, the liquid sample creates a reaction volume over the reactive site upon contacting the bottom surface of the slide.

In one embodiment, the shoulder is present and placement of the slide on the shoulder creates a closed incubation chamber preventing the liquid samples from evaporation and outside contamination.

In one embodiment, further comprising the step of securing the slide to the chip.

In one embodiment, the slide is secured to the chip using a weight or with a screw.

In one embodiment, the method is carried out without use of a gasket.

Another embodiment provides a method comprising providing a chip comprising a first surface comprising a plurality of wells of a first volume on the first surface; providing a slide comprising a first surface and at least one array of reactive sites on the first surface; disposing at least one liquid sample of a second volume into at least one of the wells, wherein the second volume substantially exceeds the first volume, and wherein the liquid sample sits within and above the well; and contacting the liquid sample with the array of reactive site, wherein a gasket is not used to surround the liquid sample.

In one embodiment, the contacting step is carried out so that the chip and the slide are separated by a predetermined distance.

In one embodiment, the array is printed on the slide by a direct write nanolithographic process.

In one embodiment, the contacting step is carried out so that the chip and the slide are separated by a predetermined distance determined by a height of a shoulder disposed on the chip.

In one embodiment, the number of wells is at least 48 and the number of reaction sites in the array is at least 48.

In one embodiment, the reaction sites are separated from each other in the array by about 10 nm to about 100 microns.

In one embodiment, the second volume is about 0.5 microliters to about 25 microliters.

In one embodiment, the well has an average well depth of about 25 microns to about 500 microns. In one embodiment, the well has an average well diameter of about 1 mm to about 5 mm.

In one embodiment, the contact results in a compression of the droplet.

Another embodiment provides an article, which comprises: a chip defining a top surface and edges surrounding the top surfaces, having at least one well on the top surface for receiving liquid, and comprising, optionally, a shoulder along the edges and elevated from the top surface; a slide disposed on the chip and defining a bottom surface and comprising at least one reaction site on the bottom surface aligned opposite of the well.

In one embodiment, the optional shoulder is present, and the slide is detachably placed on the shoulders for contacting and drawing liquid from the well onto the reactive site.

In one embodiment, the chip is made of plastic.

In one embodiment, the chip is a solid piece of plastic of rectangular shape with machined top surface.

In one embodiment, the number of wells is at least 48.

In one embodiment, the wells are disposed on the top surface in an array layout.

In one embodiment, the distance between the wells matches the pitch between the tips of commercially available multichannel pipettes or liquid handling systems.

In one embodiment, the well is of round shape.

In one embodiment, the depth of the well is less than 500 um.

In one embodiment, the depth of the well is less than 300 um.

In one embodiment, the depth of the well is less than 160 um.

In one embodiment, the volume of the well is less than 2.5 ul.

In one embodiment, the volume of the well is less than 1 ul.

In one embodiment, the shoulder is present and the height of the shoulder is no more than 450 um.

In one embodiment, the shoulder is present and the height of the shoulder is no more than 200 um.

In one embodiment, the slide is made of glass.

In one embodiment, the slide is a solid piece of epoxy glass.

In one embodiment, the slide is a solid piece of epoxy glass printed with an array of antibodies to form the reaction sites.

In one embodiment, the reaction site is printed onto the slide via a direct write nanolithography process, such as a Dip Pen Nanolithography process.

In one embodiment, the position of the reaction site matches the position of the well.

In one embodiment, the reaction site comprises capture molecules capable of capturing one or more analytes.

In one embodiment, the bottom surface of the slide is hydrophilic.

In one embodiment, the placement of the slide on the shoulders create a closed incubation chamber preventing both outside contamination and liquid evaporation.

In one embodiment, further comprising a weight being placed on the slide for securing the slide on the chip.

In one embodiment, further comprising a screw for securing the slide on the chip.

Another embodiment provides an article comprising: a chip of rectangular shape made of plastic, said chip comprising a top surface being machined, edges surrounding the top surfaces, a plurality of wells on the top surface for receiving liquid, and shoulders along the edges and elevated from the top surface; a slide made of epoxy glass, said slide comprising a bottom surface of hydrophilic nature and a plurality of capture molecules on the bottom surface; wherein the depth of the well is no more than 160 um, the volume of the well is no more than 1 ul, the height of the shoulder is no more than 450 um, the number of the wells is selected from the group consisting of 48, 96, 384, and the distance between the wells matches the pitch between the tips of commercially available multichannel pipettes or liquid handling systems; wherein the capture molecules is printed on the bottom surface via a direct write nanolithography process, such as a Dip Pen Nanolithography process, the capture molecules are capable of capturing at least one analyte from a liquid sample, and the position of the capture molecules matches the position of the wells; and wherein the slide is detachably placed on the shoulders, is capable of contacting and drawing liquid from the well onto the capture molecules, and is capable of creating a closed incubation chamber preventing both outside contamination and liquid evaporation.

Another embodiment provides a method comprising: providing a chip comprising a first surface comprising a plurality of wells of a first volume on the first surface; providing a slide comprising a first surface and at least one array of reactive sites on the first surface; disposing bulk liquid over the wells, and; contacting the bulk liquid with the array of reactive sites.

At least one advantage for at least one embodiment includes nanoscale protein detection.

At least one advantage for at least one embodiment includes the capability for sealing the liquid sample between the chip and the slide, which protects the liquid sample from evaporation, outside contamination, and allows long incubation time.

At least one advantage for at least one embodiment includes keeping liquid samples within an extremely small area on a slide with no structural modifications to eliminate cross contamination with surroundings.

At least one advantage for at least one embodiment includes eliminating the need to make, use, or clean a gasket.

At least one advantage for at least one embodiment includes minimum use of samples and reactive sites, or assays, while generating large amount of data.

At least one advantage for at least one embodiment includes the presence of for example, as many as 384 individual reaction wells that offers the capability for massively parallel quantitative measurements at a scale that was previously not available.

At least on advantage for at least one embodiment includes the capability of generating at once a set of data that would take significant labor and require a significant amount of biological material if using conventional Elisa or large gasket format.

At least on advantage for at least one embodiment includes a minimum use of materials while generating large amounts of data. There is minimal if any waste of expensive reagents and biological samples due to extremely low reaction volumes (sub-microliter to nanoliter level per reaction).

At least one advantage for at least one embodiment includes the ease for manual and automated applications.

At least one advantage for at least one embodiment includes the capability of the gasket less platform to be engineered to adapt various experimental settings for different applications. Custom designs are easily available.

At least one advantage for at least one embodiment includes low production cost of the chip.

At least one advantage for at least one embodiment includes the flexible format: for example, 48, 96, and 384 reaction wells, or any within the range are available for diverse applications.

At least one additional advantage for at least one embodiment includes the ability to shake, dry or perform other operations automatically, as well as the ability to run continuously 24/7 by replenishing the slide, sample, and bath input stacks and removing output stacks

### BRIEF DESCRIPTION OF THE DRAWINGS

FIG. 1 illustrates one embodiment in a cross-sectional view showing (a) the structure of the chip, (b) the shape of the liquid samples sitting in the wells, (c) the placement of the slide, and (d) the transformation of the shape of liquid samples upon contacting the slide.

FIG. 2 illustrates one embodiment in a cross-sectional view, showing the geometrical features of one well and one shoulder on the chip, and the shape of one liquid sample sitting in the well. The top of the liquid sample sitting in the well is higher than the top of the shoulder.

FIG. 3 illustrates two embodiments in a top view, showing the layouts and geometrical features of two chips. The layouts are designed to be compatible with commercially available multichannel pipettes and liquid handling system.

FIG. 4 illustrates two embodiments (middle & right) and a prior art example (left) in a top view, showing a comparison of the layout and features among them. Compared to the prior art, this embodiment uses substantially less liquid sample per well.

FIG. 5 illustrates one embodiment in a top view, showing fluorescence images of 4×12 format microarrays at different analyte quantities.

FIG. 6 illustrates one embodiment in a top view, showing fluorescence images of 4×12 format microarrays at different analyte quantities.

FIG. 7 illustrates one embodiment, showing standard curves built based on fluorescence images, and reproducibility of each cytokine on a single slide.

FIG. 8 illustrates two embodiments (middle & right) and a prior art example (left) in a top view, showing a comparison of fluorescence images of assays.

FIG. 9 illustrates one embodiment and a prior art example in a top view, showing a comparison of fluorescence images at different analyte quantities.

FIG. 10 illustrates one embodiment, showing the standard curves built from the fluorescence images acquired from 18 and 48 well format.

FIG. 11 illustrates one embodiment, showing fluorescence intensity curves at femtogram per mil concentrations of target molecules.

FIG. 12 illustrate one embodiment, showing fluorescence intensity peaks at different concentrations of target molecules.

FIG. 13 illustrates one prior art embodiment showing the use of a gasket (element 3).

FIG. 14 illustrates, in a partially exploded view, an embodiment wherein no gasket is used. Droplets of liquid are used.

FIG. 15 illustrates an embodiment, in exploded view, wherein no gasket is used and screws are used to assemble the device. Bulk liquid can be used rather than droplets.

FIG. 16 illustrates an embodiment wherein the device is assembled and inverted. Bulk liquid can be used rather than droplets.

FIG. 17 illustrates a commercial pipetting device which can be used.

FIG. 18 shows an embodiment wherein a sample tray is illustrated showing three separate zones which have a chip embedded into the zone.

### DETAILED DESCRIPTION

### Introduction

All references cited herein are incorporated by reference in their entireties.

Priority U.S. provisional application Ser. No. 61/409,062 filed Nov. 1, 2010 is hereby incorporated by reference in its entirety. Also, filed on the same day, Nov. 1, 2010, is US provisional application entitled “HIGH-THROUGHPUT SLIDE PROCESSING APPARATUS” to Bussan et al., assigned to NanoInk, Inc., Ser. No. 61/409070, which is incorporated herein by reference in its entirety. This application describes generally how the assay devices and methods as described herein can be used with a work station using trays. For example, the slides and chips described herein can be adapted as needed for use with slide trays and sample trays which can be handled by automated work stations.

Co-filed with the present application is U.S. utility application “HIGH-THROUGHPUT SLIDE PROCESSING APPARATUS” to Bussan et al., assigned to NanoInk, Inc., Ser. No. ______, which is hereby incorporated by reference.

Printing based on nanoscopic tips is described in, for example, U.S. Pat. Nos. 6,635,311; 6,827,979; 7,361,310; 7,569,340; 7,722,928; and patent publication nos. 2003/0068446 and 2005/0009206, as well as WO/2009/132321 published Oct. 29, 2009 re polymer pen lithography (Northwestern University), which are hereby incorporated by reference. These methods can be used to prepare microarrays and print assays or reactive sites. Other printing methods such as stamping and direct write lithography are known.

Microarrays are generally known in the art. See, e.g., Kohane, Kho, and Butte, Microarrays for an Integrative Genomics, 2003; and Müller, Roder, Microarrays, 2006. For example, the Muller text describes protein microarrays, nucleic acid microarrays, microarray detection, and microarray marking systems. It also describes microarray spotters, microarray scanners and digitizing, microarray software and documentation, additional laboratory equipment, and clean room technology.

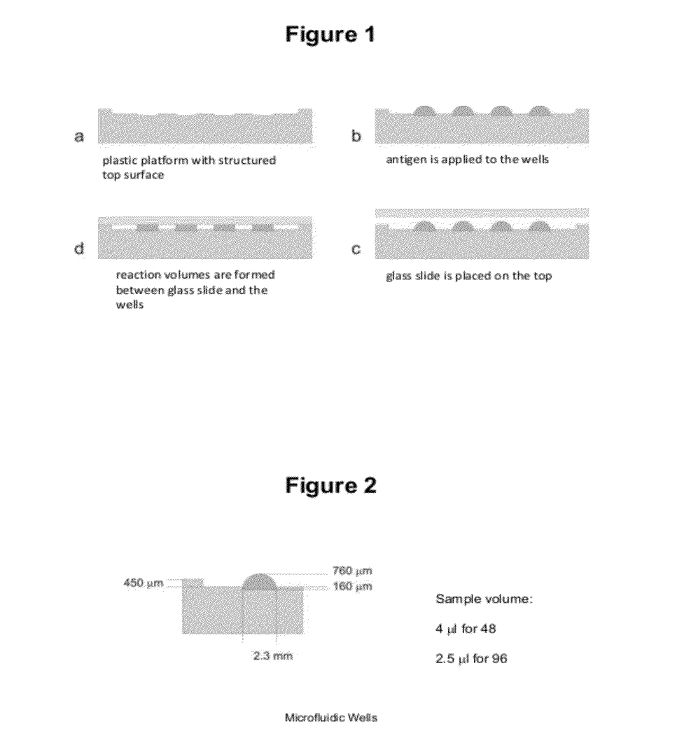

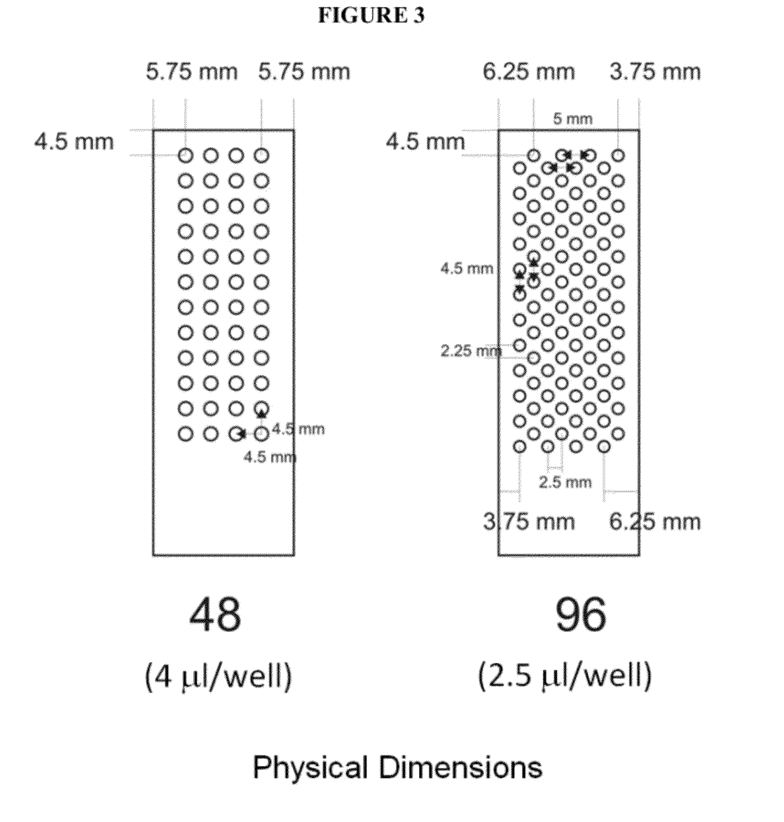

In embodiments described herein, the microfluidic chip presents a structured plastic platform comprising periodically distributed reaction wells. In one embodiment, a design and cross-section of the chip are shown in FIGS. 1 and 2. In one embodiment, the base platform presents a solid piece of plastic with machined top surface which houses microfluidic wells and supports microarray glass slide on a predetermined, relatively precise or exact, distance from the wells. Optionally, shoulders on the chip can be used to control this predetermined distance. The positions of the wells, in one embodiment, match the positions of the reaction sites printed on the slide, and spacing between the well are the same used by existing commercial technologies, as shown in FIG. 3. In one embodiment, when the slide is placed on the chip, solution from the wells reaches the glass surface creating a reaction volume over the assays, as shown in FIG. 1d. In one embodiment, with the slide on the chip, the assembly presents a closed incubation chamber that prevents liquids in the wells from evaporation. In one embodiment, the capacity of the reaction volume is defined by the well dimensions and can vary from the sub-microliter to nanoliter level per reaction.

In typical experiment to run assay, the wells are first filled with liquid media using, for example, either multichannel pipettes or liquid handling robots. A glass slide with printed reaction sites is applied upside down within the area controlled by vertical and horizontal walls of the microfluidic chip. The solution from the wells comes in touch with the glass surface as the slide reaches the (optional) shoulders on the chip. Due to hydrophilic properties of glass the liquid spreads over the glass surface (physical wetting) but does not leave the well as a result of strong cohesive forces within the liquid. In the assembled position the volume between the glass slide and the chip is sealed that preserves the liquids from evaporation and outside contamination. Within the chamber water vapors comes to the equilibrium with liquid phase that guarantees constant humidity environment and long incubation time if required.

With the gasket-less approach, the number of individual reaction wells can be as many as, for example, 384 wells that offers the capability for massively parallel quantitative measurements at a scale that was previously not available. The high-throughput assays generate at once a set of data that would take significant labor and require a significant amount of biological material if using conventional Elisa or large gasket format. The gasket-less platform can be engineered to adapt various experimental settings for different applications. For example, coupling high-throughput analysis to high-density printing methods (like DPN) will result in high-content screening and quantification of proteins in biochemical assays.

In describing FIG. 1, the relative position terms like “top” and “bottom” can be used although in principle, the positions could be reversed. The top surface and/or the bottom surface can be also referred to as a first surface. The chip or the slide can have multiple opposing, coplanar, parallel surfaces including a top and a bottom surface, and a first or a second surface.

### Providing a Chip

Providing a chip includes the making of a chip as described herein or otherwise acquiring the chip. The latter includes the purchasing and/or renting of the chip made by others.

### Chip

Chips known in the art for biochemical assays can be used. The chip can be rigid or flexible. It can be flat. An exemplary chip is shown in FIG. 1a. A single device can be also built comprising one or more chips such as, for example, three chips. FIG. 18 also shows an example where a sample tray comprises three zones each comprising a chip.

The chip can comprise common structural materials like, for example, a glass, composite, synthetic polymer, or a plastic, materials having a similar hydrophobicity as plastics, or a coating of plastics and/or materials having a similar hydrophobicity as plastics. The chip can be an epoxy. The chip can be a chemically resistive material. The chip can be surface treated if desired. The chip can be cleaned.

The chip can also be called a substrate platform. The chip can be rectangular or square. The chip can be shaped to be useful in functioning with a microscope slide and can the length and width of a microscope slide.

One embodiment of the chip is a solid piece of plastic with machined top surface. In another embodiment, a substrate such as a glass substrate has a patterned layer disposed on it. Holes in the patterned layer form the well. Wells of the chip are formed from a patterned layer formed on a substrate.

The chip can be adapted to mechanically couple with other mechanical support structures.

### Top Surface and Edges

The chip can include one surface defined as the top surface on which a plurality of wells are present. Other than the wells, the rest of the top surface can be flat. The boundary of the top surface can be defined by its edges. For example, the top surface and edges of a 48-well chip and a 96-well chip are shown in FIG. 3.

### Wells

A plurality of wells are present on the top surface of the chip. A well in this embodiment can also be called a recess. The number of wells can be, for example, 48, 96, or 384.

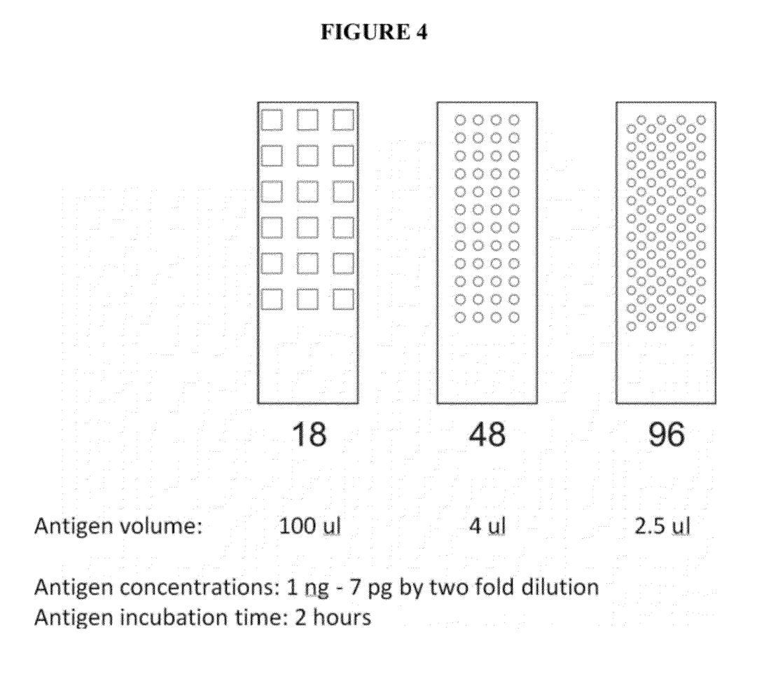

Layouts of the wells are shown, for some embodiments, in FIGS. 3 and 4. For example, for a 48-well chip, the layout of the wells can be a 4 by 12 array, while the distance between neighboring wells can be 4.5 mm. Layouts of wells known in the art for biochemical assays can be used.

The well can be round, rectangular, square, elliptical, or any other suitable shape. Exemplary round-shaped wells are shown in FIG. 3. Shapes of wells known in the art for biochemical assays can be used.

The well can be shallow. The depth of the well can be, for example, about 25 microns to about 500 microns, or about 100 microns to about 250 microns, or about 140 microns to about 180 microns. In one embodiment, it is 160 um.

The diameter, length, or width of the well can be, for example, about 1 mm to about 5 mm, or about 1.5 mm to about 3 mm. In one embodiment, it is 2.3 mm.

The size of An exemplary well is shown in FIG. 2.

The volume of liquid in the liquid droplet can be, for example, about 0.5 microliters to about 25 microliters, or about 1 microliter to about 10 microliters, or about 2 microliters to about 5 microliters.

The distance between the wells with respect to (i) other wells, and/or (ii) the edge of the chip, can be adapted. Distances can be, for example, about 0.5 mm to about 20 mm, or about 1 mm to about 10 mm. Distance can be measured from the center of the well. Exemplary distances are shown in FIGS. 3 and 4, for example, including 3.75 mm, 4.5 mm, 5.75 mm, and 6.25 mm.

The volume of liquid sample to be applied to the wells can exceed, including substantially exceed, the volume of the well. For example, 4 ul of liquid sample can be applied to each well on the 48-well chip, 2.5 ul of liquid sample can be applied to each well on the 96-well chip, while 1 ul of liquid sample is applied to each well on the 384-well chip.

The height of the droplet as measured to the bottom of the well can be, for example, about 400 microns to about 1.5 mm, or about 500 microns to about 1 mm, or about 600 microns to about 900 microns. In one embodiment, it is about 760 microns.

As exemplified in FIG. 2, the height of the liquid sample sitting in the well can be 760 um, while the depth of the well can be only 160 um.

The well can be formed by forming a patterned layer or film on top of another layer or underlying substrate, wherein a hole in the pattern creates the well. For example, a patterned hydrophobic polymer layer (e.g., layer made of polytetrafluoroethylene) can be placed over a more hydrophilic substrate such as glass. The wells of the chip are formed from a patterned layer formed on a substrate.

### First Volume

The volume of a well can be defined as a first volume. For example, as shown FIG. 2, the diameter and depth of the well can be 2.3 mm and 160 um respectively. As shown in FIG. 3, the well can be round-shaped. The first volume of such An exemplary well can be calculated accordingly. Importantly, the first volume can be substantially exceeded by the volume of a liquid sample, which is placed in the well.

### Predetermined Distance and Shoulders

The device can be adapted so that the chip and the slide are separated by a predetermined distance as they are positioned together and form a sealed environment. A variety of methods and designs can be used to control this predetermined distance. In a preferred embodiment, optionally, shoulders on the chip can be used to control this predetermined distance.

The chip also can include shoulders along the edges and elevated from of the top surface. The shoulders enclose the top surface. The shoulder can also be called a wall. Shoulders/walls known in the art for biochemical assays can be used.

The shoulders can be a continuous elevation of unanimous height from the top surface of the chip. The height of the shoulders can also vary as long as it fit with the contours of the bottom surface of the slide to seal the top surface from outside contamination.

The shoulder height can be, for example, 100 microns to 1 mm, or 250 microns to 650 microns, or 350 microns to 550 microns.

The height of the top surface should not exceed the height of the liquid sample sitting in the well, as calculated from the top surface. For example, as shown in FIG. 2, the height of the shoulder can be 450 um when the top of the liquid sample is 600 um above the top surface.

### Administering A Liquid Sample

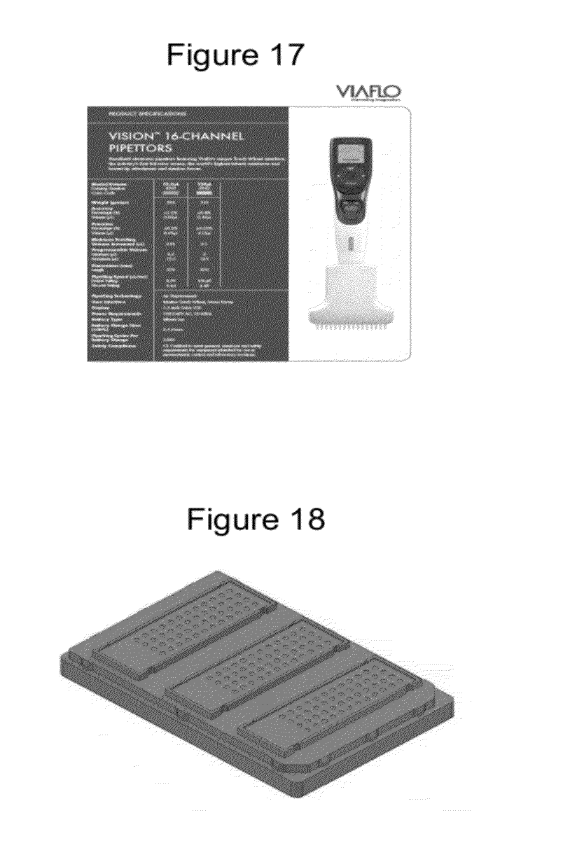

Methods of administering or disposing a liquid sample known in the art for biochemical assays can be used. Liquid samples can be administered manually. Users can use a single pipette or multichannel pipettes for the manual administration. See, for example, FIG. 17. Samples can also be administered through a automated liquid handling systems, as the chip is adapted for such purpose. For example, in manual operation of the device, a user applies defined volume to, for example, 12 wells at once and repeats the step, e.g., three or more times. The total time to fill all 48 wells is, for example, not more than 30 sec.

For example, as shown in FIG. 3, for every high throughput format (48-, 96- or 384-well chip), the distance between the wells can match the pitch between the tips of commercially available multichannel pipettes or liquid handling systems. In manual operation of the device, users can apply defined volume to 12 wells at once and repeat the step multiples times. The total time to fill all 48 well can be, for example, not more than 30 sec. While the 48- and 96-well chips can be processed in manual operation, it is recommended that the 384-well chip is processed using robots.

### Liquid Sample

Liquid sample known in the art for biochemical assays can be used. They can include peptide and proteinaceous materials, and/or nucleic acid materials. The liquid sample can comprise, for example, blood or urine of a human or a animal. The liquid sample can be made from tissues or cells of a human or animal. The liquid sample can be extracts of a plant or fungi. The liquid sample can comprise virus, bacteria, or any other pathogens. The liquid sample can comprise antigens and any other analytes detectable via biochemical assays. See, for example, Alberts et al., Molecular Biology of the Cell, 5^{th} Ed., 2007 and Lodis et al., Molecular Cell Biology, 5^{th} Ed., 2007.

Water can be used in the liquid sample.

Different liquid samples can be used in different drops.

### Second Volume

The volume of a liquid sample is defined as the second volume. For example, as shown in FIG. 2-3, An exemplary liquid sample sitting in a well can have a height of 760 um, a diameter of 2.3 mm, and a shape of a hemisphere. The second volume of such An exemplary liquid sample can be calculated accordingly. Importantly, the second volume substantially exceeds the volume of a well. In one embodiment wherein the chip includes 48 wells, the second volume is 4 ul. In another embodiment wherein the chip includes 96 wells, the second volume is 2.5 ul. In one embodiment wherein the chip includes 384 wells, the second volume is 1 ul. Depending on the specific requirement of an experiment, the second volume can be changed in a large range by changing the depth of the wells

### Placing A Slide

After liquid samples are administered into the wells, a slide can be placed on the chip. The bottom of the slide can be adapted and can contain contours that match the top of the optional shoulders. Thus, the placement of the slide onto the optional shoulders can create a closed incubation chamber free of outside contamination or liquid evaporation.

Placing the slide can be achieved manually or through a automated system. For example, users can manually place the slide on the chip from the top. Optionally, users can secure the slide using a weight or with a screw. In the secured stage, the slide is secured from any motion that assures that liquid volumes formed between the chip and the slide remain in the initial position till the slide is removed.

### Slide

Slides known in the art for biochemical assays can be used. The slide can be rigid or flexible. It can be flat. The slide can be rectangular or square. An exemplary slide is shown in FIGS. 1c and 1d. The slides can be also used in a slide tray.

The slide can comprise glass, materials having a similar hydrophobicity as glass, or a coating of glass and/or materials having a similar hydrophobicity as glass. The slide can be surface treated if desired.

Depending on the application or the particular experimental settings, the slide can be a piece of plastic (treated or non treated chemically, or coated with metal layer), metal (same as plastic treated or coated with chemical or metal coating), or a different type of glass or silicon or silicon based material.

The slide can also be called a microarray, as an array of capture molecules or assays can be printed on the bottom surface of the slide. One preferred embodiment of the slide is a solid piece of epoxy glass printed with an array of antibodies via a direct write nanolithography process, such as a Dip Pen Nanolithography (DPN) process.

The slide can be, for example, about 0.5 inches to about 2 inches wide, and about 1 inch to about 5 inches long. Microscope slides can be, for example, about one inch wide and about three inches long. The slide tray comprise, for example, three or more slides.

### Bottom Surface of the Slide

The bottom surface of the slide is defined as the surface on which reaction sites, or assays, are immobilized. When the slide is placed on the chip, the bottom surface of the slide can face the top surface of the chip. The distance between the bottom surface of the slide and the top surface of the chip can be sufficiently close that the top of the liquid sample sitting in a well will contact the bottom surface of the slide.

Moreover, the bottom surface of the slide is preferred to be more hydrophilic while both the top surface of the chip and the surface of the wells are preferred to be more hydrophobic.

### Reaction Sites

Reaction sites, or assays, known in the art for biochemical assays can be used. The reaction site can comprise a biological material including, for example, a peptide or proteinaceous material, and/or a nucleic acid material. The reaction sites or assays can comprise antibodies generated from immune responses of a human or animal. The assay can bind specifically to one or more antigens or any other analytes detectable via biochemical assays. See, for example, Alberts et al., Molecular Biology of the Cell, 5^{th} Ed., 2007 and Lodish et al., Molecular Cell Biology, 5^{th} Ed., 2007.

A variety of printing methods can be used pattern the reaction sites. Serial or parallel methods can be used. Contact or non-contact methods can be used. Stamping methods can be used. Ink jet printing or spotting can be used. Direct write nanolithography can be used.

In an preferred embodiment, the assays are an arrays of antibodies printed on a glass slide via, for example, a DPN process. The DPN method is described in, for example, U.S. Pat. Nos. 6,635,311; 6,827,979; and 7,744,963 (Mirkin et al.). Using the DPN method, the number of spots printed can be as high as hundreds that allows achieving good statistical results.

The layout of the assays on the slide is preferred to mirror the layouts of the wells on the chip to achieve maximum efficiency. Consequently, in a preferred embodiment, when a slide is placed on the chip, each assay printed on the bottom of the slide will be positioned directly above each well on the chip.

The reaction site can be printed to have a diameter of, for example, about 10 nm to about 100 microns, or about 100 nm to about 50 microns, or about 500 nm to about 25 microns.

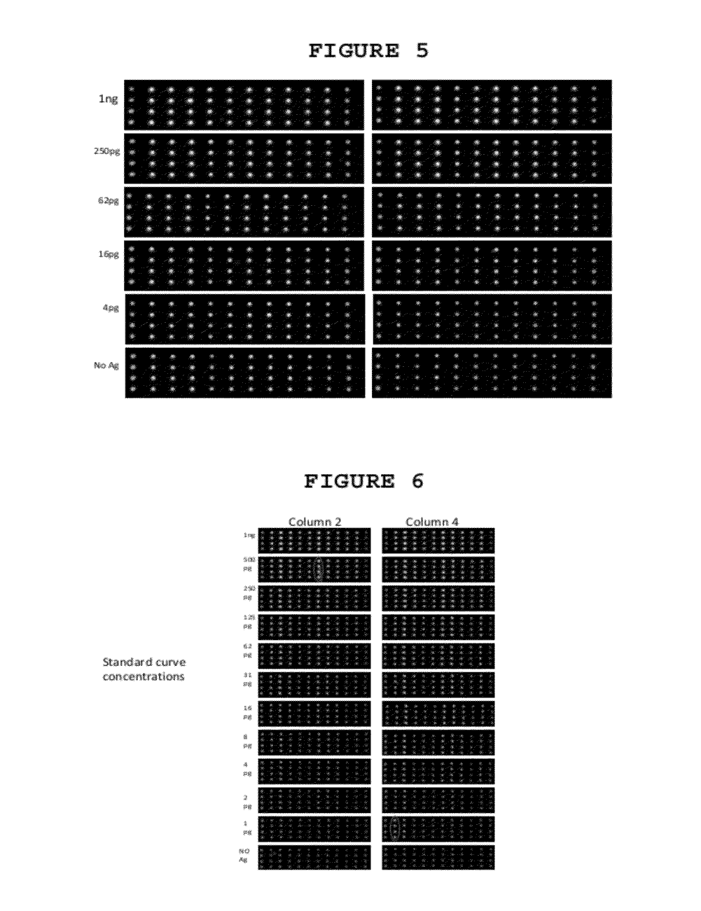

In a preferred embodiment, a single droplet can contact a series of reaction sites. For example, a single droplet can contact an array of reaction sites. In this array, the identity of the reaction site can be the same. For example, FIGS. 5 and 6 show an array of reaction sites. The array can be, for example, a 4×12 array (48 reaction sites). The use of multiple reaction sites in a single droplet improves the statistical accuracy of the measurement. The distance between the reaction sites can be, for example, about 10 microns to about 100 microns, or about 25 microns to about 75 microns.

### The Liquid Sample Being Drawn to the Reaction Site

When the slide is placed on the chip, liquid samples sitting in the wells can make contact with the bottom surface of the slide. Because of the hydrophobicity of the bottom surface of the slide exceeds the hydrophobicity of both the top surface of the chip and the surface of the well, the liquid sample is drawn upwards upon contacting the bottom surface of the slide. An example is shown in FIGS. 1c and 1d.

In a preferred embodiments, when a slide is placed on the chip, each reaction site or assay printed on the bottom of the slide is positioned directly above each well on the chip. Thus, upon contacting the bottom surface of the slide, the liquid sample is drawn upwards to form a incubation volume on the reaction site or assay directly above it.

### Additional Processing

Additional processing, washing, and detection steps can be carried out as known in the art of assaying. For example, ELISA (enzyme-linked immunosorbent assay) is well-known in the art in different forms. Automation devices and work stations can be used.

### Detection

Detection can be carried out by use of fluorescent scanning For example, a commercial InnoScan® 900s Fluorescence Scanner can be used.

### Work Stations

In one embodiment, steps can be carried out with a work station. For example, one embodiment provides a method comprising providing a chip comprising a top surface, edges surrounding the top surface, a plurality of wells of a first volume on the top surface, and, optionally, shoulders along the edges and elevated from the top surface; wherein the chip is adapted to function with a work station; providing a slide comprising a bottom surface and at least one reactive site on the bottom surface; wherein the slide is adapted to function with a work station; administering at least one liquid sample of a second volume into at least one of the wells, wherein the second volume substantially exceeds the first volume, and wherein the liquid sample sits within and above the well; wherein the administering step is carried out with a workstation; and placing the slide over the chip such that the reactive site is positioned above at least one of the wells and contacts the liquid sample, wherein the placing is carried out with a work station.

Work stations are known in the art. In additional, novel work stations are described in U.S. 61/409,070, which is incorporated herein by reference in its entirety.

### Embodiments of FIG. 1-4

Additional embodiments are described in the figures.

For example, FIG. 1a shows one embodiment wherein a chip has a top surface, a plurality of wells on the top surface, and shoulders surrounding the top surface. FIG. 1b shows the liquid samples sitting in the wells in a hemisphere shape, wherein the top of the liquid sample is higher than the top of the shoulder. FIG. 1c shows a slide being placed onto the shoulders. FIG. 1d shows that, when the slide is placed onto the shoulder, the liquid samples transform to a cylinder shape upon contacting the slide.

FIG. 2 shows one embodiment wherein the volume of the liquid sample is shown to be substantially larger than the volume of one well. Even so, the liquid sample sits within and above the well in a hemisphere shape, without spreading onto the surrounding areas. The depth of the well is shown to be only 160 um. The liquid sample is shown to have a height of 760 um, higher than the height of the should combined with the depth of the well.

FIG. 3 shows two embodiments wherein the chips include 48 and 96 wells respectively. The chips are of rectangular shape. The layout of the wells are designed to be compatible with commercially available multichannel pipettes and liquid handling system. For the 48- and 96-well chip, the volumes of the liquid sample to be administered are 4 ul and 2.5 ul, respectively.

FIG. 4 shows two embodiments in comparison to a prior art chip. The prior art chip only contains 18 wells and requires 100 ul of liquid sample for each well. One embodiment contains 48 wells and requires 4 ul of liquid sample for each well. Another embodiment contains 96 wells and requires 2.5 ul of liquid sample for each well.

### Bulk Liquid Embodiments

Another embodiment provides a method comprising providing a chip comprising a first surface comprising a plurality of wells of a first volume on the first surface; providing a slide comprising a first surface and at least one array of reactive sites on the first surface; disposing bulk liquid over the wells, and; contacting the bulk liquid with the array of reactive sites.

The slide and/or the chip can be adapted to allow introduction of bulk liquid. In this embodiment, droplets are not formed.

The bulk liquid can comprises samples or other compositions for interactions with the reaction sites.

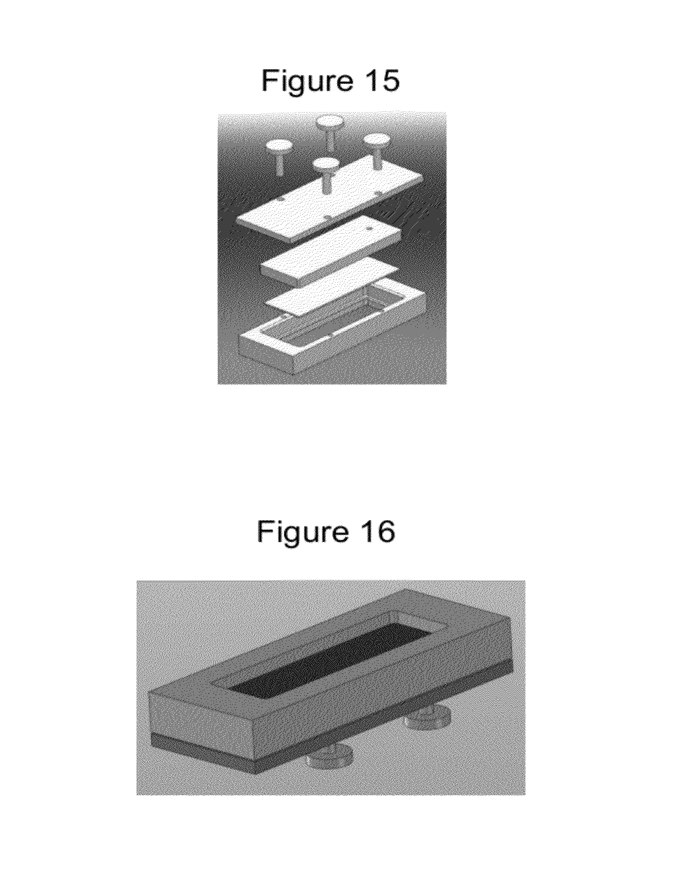

See, for example, FIGS. 15 and 16.

### Applications

For embodiments described herein, applications include drug discovery and proteomic applications including, for example, protein profiling, biomarker discovery/detection, angiogenic factor screening, growth factor and signal transducer screening, cell cycle protein and transcription factor screening, cytokine expression profiling, apoptosis protein screening, protease screening, chemokine and adipokine screening, and toxicity screening.

Particular assays include, for example, human inflammation cytokine protein assay, human angiogenesis assay, rodent toxicology assay, or human matrix metalloproteinase assay.

### LITERATURE

Additional applications and teachings are described in the following references which can be used:

Non-patent literature:

1. Huang et al., “High-throughput genomic and proteomic analysis using microarray technology,” Clinical Biochmistry, 47(10):1912-1916 (2001).

2. Dunn & Feygin, “Challenges and solutions to ultra-high-throughput screening assay miniaturization: submicroliter fluid handling, DDT, 5(12):S84-S91 (2000).

3. Templin et al., “Protein microarray technology,” Trends in Biotechnology, 20(4):160-166 (2002).

4. Heller, “DNA microarray technology,” Annu. Rev. Biomed. Eng., 4:129-153 (2002).

5. Ochsner et al., “Micro-well arrays for 3D shape control and high resolution analysis of single cells,” Lab Chip, 7:1074-1077 (2007).

6. Khademhosseini et al., “Co-culture of human embryonic stem cells with murine embroni fibroblasts on microwell-patterned substrates,” Biomaterials, 27:5968-5977 (2006).

### Patents or Published Patent Applications:

1. U.S. Pat. No. 7,736,594, “Reaction surface array diagnostic apparatus.”

2. U.S. Pat. No. 7,666,362, “Micro-plate and lid for robotic handling.”

3. U.S. Pat. No. 7,166,257, “Multiwell test apparatus.”

4. U.S. Pat. No. 7,128,878, “Multiwell plate.”

5. U.S. Pat. No. 6,939,709, “Multi-well device.”

6. U.S. Pat. No. 6,720,143, “Genetic assay system.”

7. U.S. Pat. No. 6,699,665, “Multiple array system for integrating bioarrays.”

8. U.S. Pat. No. 6,436,050, “Multi-well platforms, caddies, lids and combinations thereof”

9. U.S. Pat. No. 6,303,387, “Method of transferring a liquid drop from a multiwell plate and/or chemical assay.”

10. U.S. Pat. No. 6,037,168, “Microbiological assembly comprising resealable closure means.”

11. U.S. Pat. No. 5,972,694, “Multi-well plate.”

12. U.S. Pat. No. 3,736,042, “Microscope slide assembly.”

13. U.S. patent application Ser. No. 10/230,028, “Immunosorbent Assay in Microarray Format.”

### WORKING EXAMPLES

### Example 1

(Embodiments of FIGS. 5-7)

A challenge of biological assay is to run the assay using minimum amount of reagents and time. A smaller array should demonstrate faster kinetic and better sensitivity. Now using high throughput format to run assay in combination with subarrays printed on glass surface by DPN it is possible to validate various hypothesizes. Both conventional and high throughput formats were run in parallel and the results we carefully compared. It has been demonstrated that performance of high through put format meets or exceed the performance of the conventional assay with saving significant amount of reagents.

Arrays fabrication: Arrays of antibodies were printed on a glass slide via Dip Pen Nanolithography (DPN) process. Due to small size of DPN features, the number of spots printed can be as high as hundreds that allows achieving good statistical results. Ten different cytokines were printed at ambient conditions (40% RH, RT) onto epoxy glass slide (Schott Nexterion) in a format shown on the FIG. 5. In all tests the spot size was controlled and measured within 5% of the specified value that was 5 um.

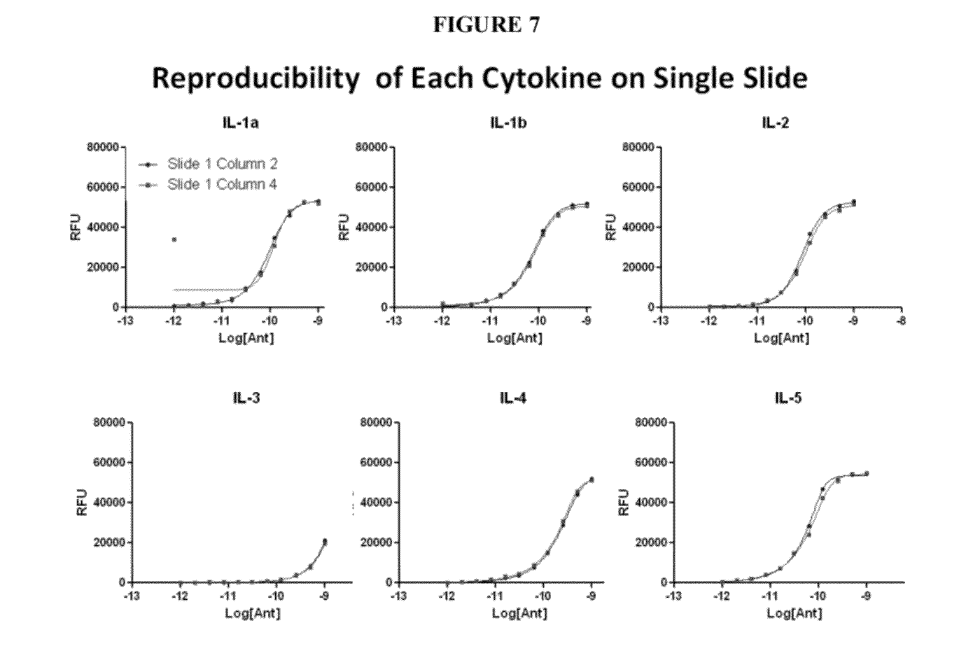

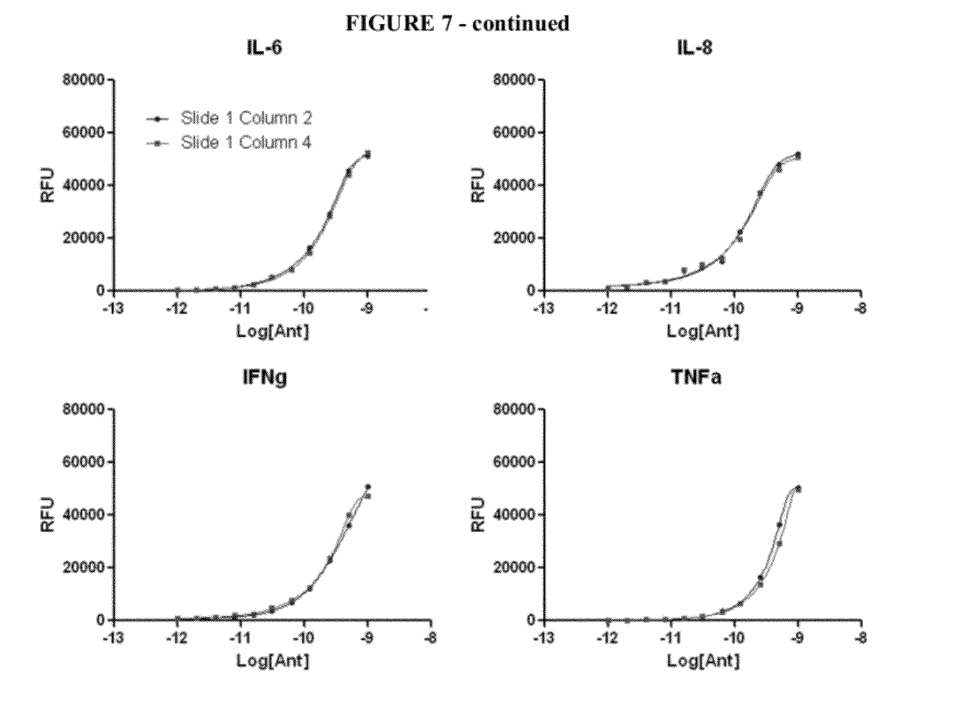

The performance of assays was tested using submicron arrays of cytokine antibodies that were processed under different experimental conditions such as concentration of capture, target and detection molecules, incubation time and environmental temperature. The protocol on every format involves several steps similar those in ELISA. Those generally include washing, blocking, antigen incubation, primary antibody incubation, and streptavidin. All the steps except antigen can be processed the same way for the whole slide and does not require anything specific per well. The antigen step is the only specific and here where high throughput devices are employed to enable running multiple tests on a single slide. Each of 48/96 wells can be used for any specific reaction or duplicate reactions to get more statistically meaningful data. After the arrays are processed with all steps the slide is scanned with a microarray scanner to acquire fluorescence images of the arrays, FIGS. 6. The obtained fluorescence images are analyzed to build standard curves which present sensitivity and repeatability of the data (FIG. 7).

### Example 2

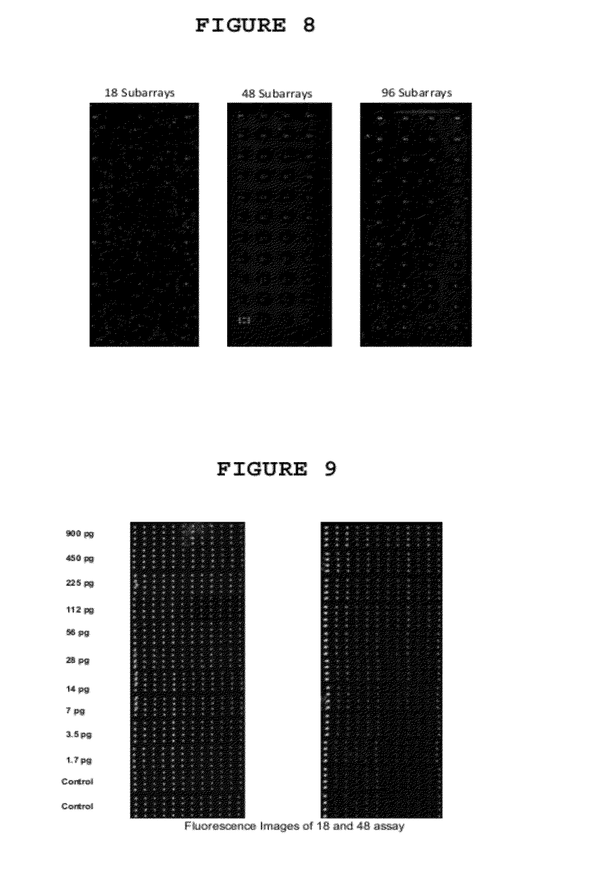

(Embodiments of FIGS. 8-12)

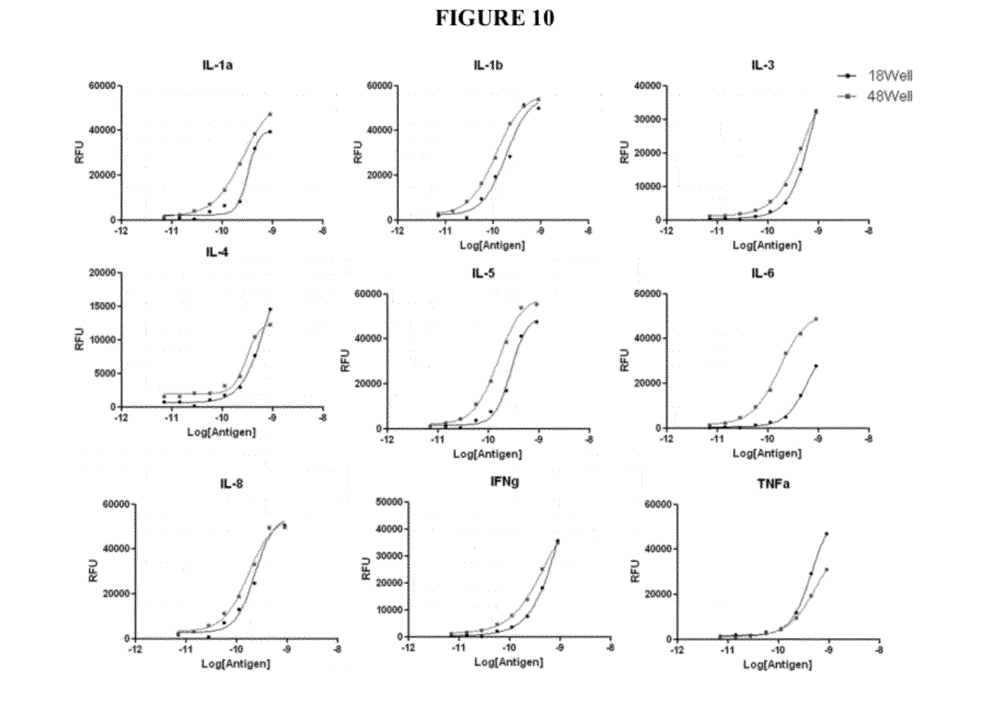

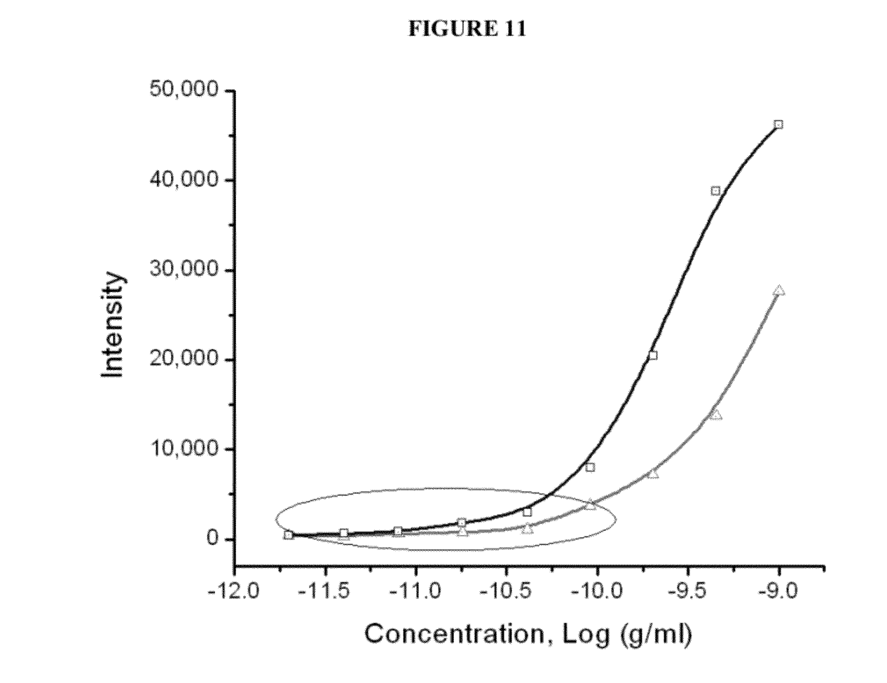

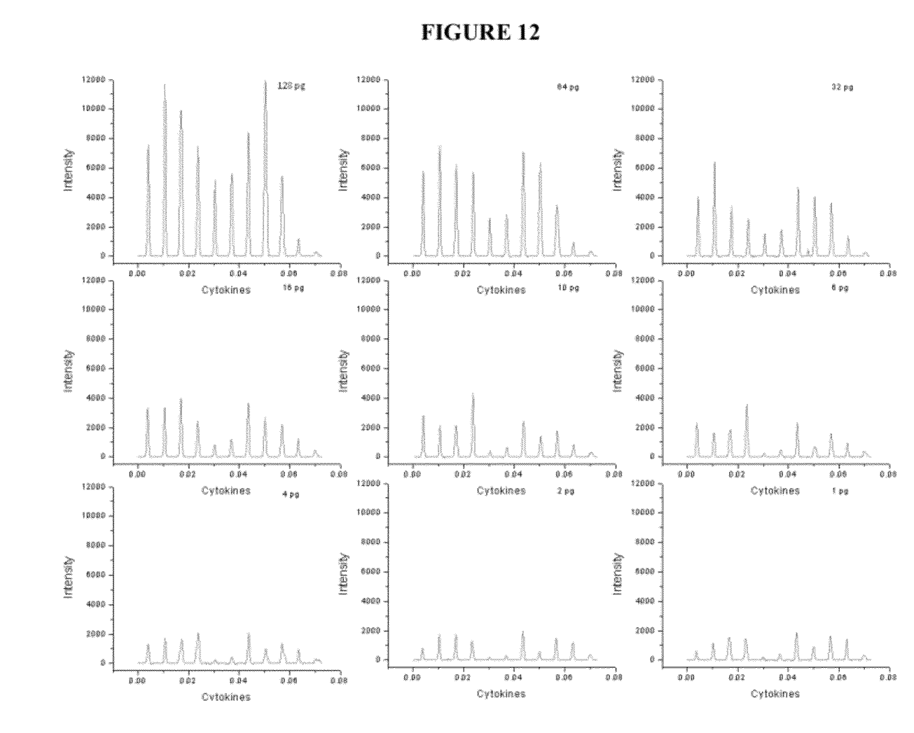

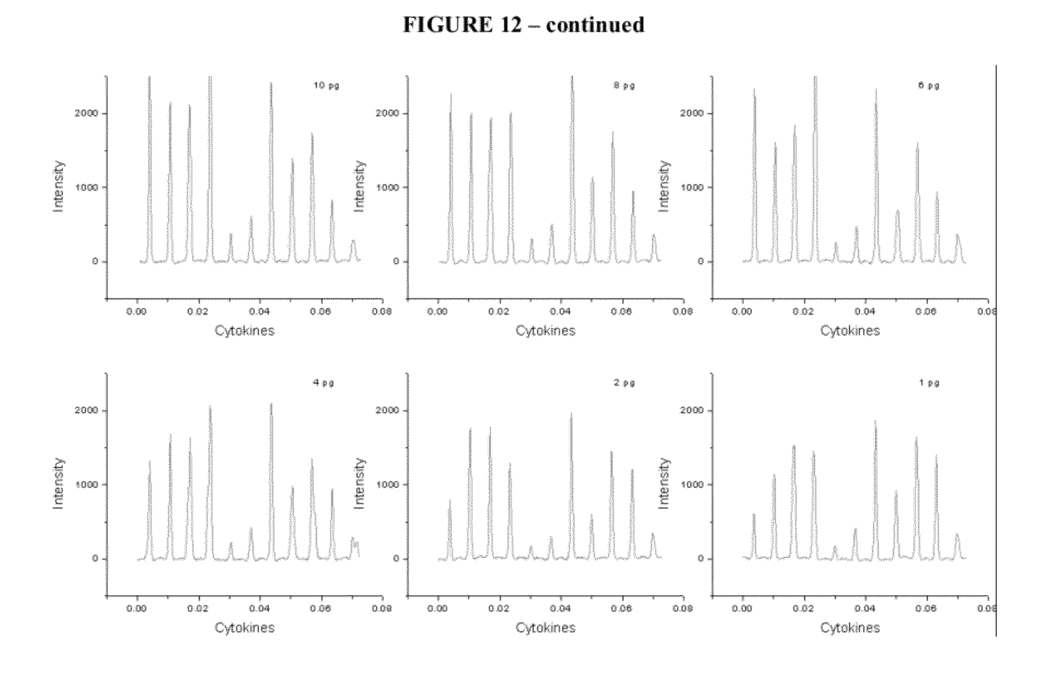

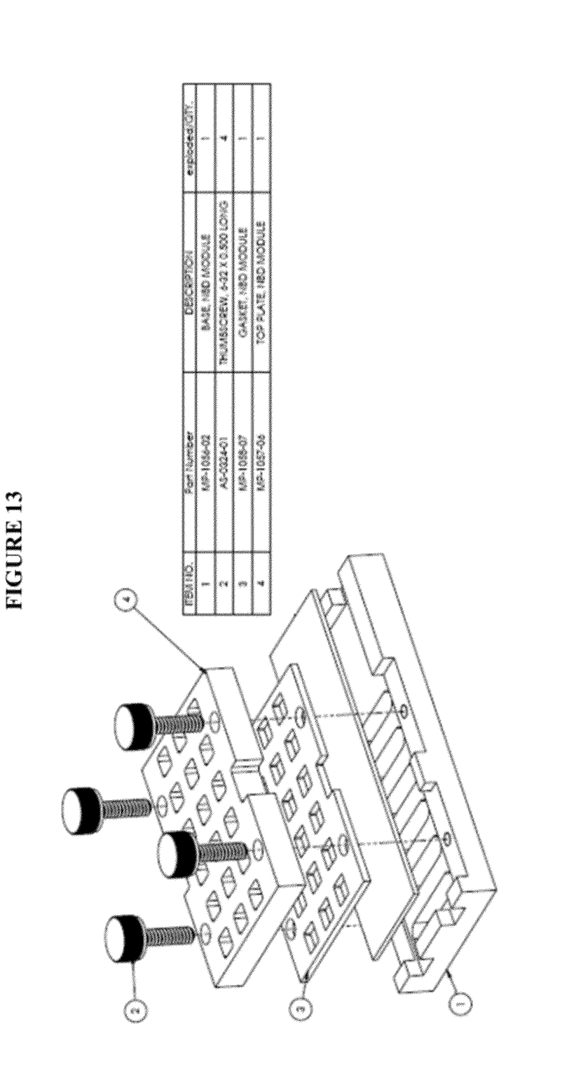

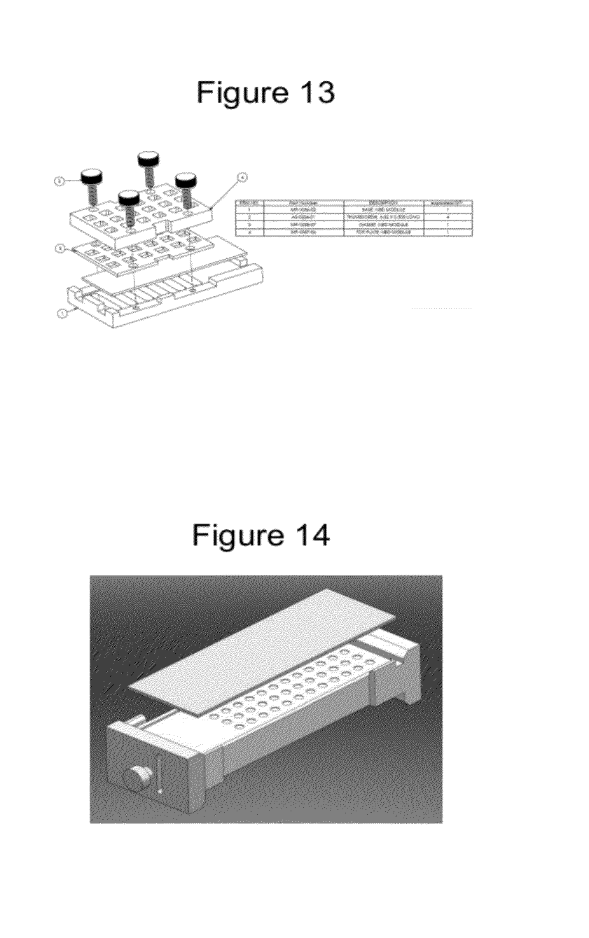

The experiments showed high adaptability and versatility of the high-throughput microarray platform compared to current (low density) format. Behind high throughput analysis the new platform keeps high efficiency, sensitivity, low cost and reproducibility of the data. The studies validated protocol of using sub-microliter volumes to run assay and demonstrated that high-throughput format generates reliable quantitative results with minimal sample usage. FIG. 8-9 demonstrates a comparison of fluorescence images of assays as using conventional 18, and 48 and 96 sub-array formats. FIG. 10 demonstrates standard curves built from the processed images. The sensitivity of high throughput analysis can be revealed from the data showing fluorescence intensity peaks at different concentrations of target molecules, as shown in FIG. 11-12.

### Embodiment 3

(FIGS. 14-18)

FIG. 14 depicts a device used for liquid assay of a slide on a chip comprising a plurality of wells. The distance between the wells can be adapted to match the pitch between tips of commercially available multichannel pipette, such as the embodiment illustrated in FIG. 17. Liquid sample droplets are placed in the wells. The slide can be placed on top of the chip contacting the liquid sample to create a plurality of reaction volumes.

FIGS. 15 and 16 illustrates a bath tray used to expose a slide to bulk quantities of assay liquids. The slide can be sealed against the frame by assembling the tray as shown in FIG. 15, with the printed array side down. The bath tray can then be turned over so that the printed side faces up, as in FIG. 16. Assay liquids and wash/buffer liquids can be added and removed multiple time to complete the assay. The bath tray can also be used for washing/buffering the slides. To further increase the throughput of assaying method described herein, a sample tray adapted to accept multiple chips can be used, such as the embodiment illustrated in FIG. 18.

What is claimed is:

1. A method comprising
providing a chip comprising a top surface, edges surrounding the top surface, a plurality of wells of a first volume on the top surface, and, optionally, shoulders along the edges and elevated from the top surface;
providing a slide comprising a bottom surface and at least one reactive site on the bottom surface;
administering at least one liquid sample of a second volume into at least one of the wells, wherein the second volume exceeds the first volume, and wherein the liquid sample sits within and above the well;
placing the slide over the chip such that the reactive site is positioned above at least one of the wells and contacts the liquid sample.

2. The method of claim 1, wherein the shoulder is not optional but present, and the placing of the slide results in the slide contacting the shoulder.

3. The method of claim 1, wherein the optional shoulder is not present.

4. The method of claim 1, wherein the chip is made of plastic.

5. The method of claim 1, wherein the number of wells is at least 24.

6. The method of claim 1, wherein the number of wells is at least 96.

7. The method of claim 5, wherein the wells are disposed on the top surface in a regular array layout.

8. The method of claim 1, wherein the distance between the wells matches the pitch between the tips of multichannel pipettes or liquid handling systems.

9. The method of claim 1, wherein the distance between neighboring wells is about 2.5 mm to about 9 mm.

10. The method of claim 1, wherein the well is of round shape.

11. The method of claim 1, wherein wells of the chip are formed from a patterned layer formed on a substrate.

12. The method of claim 1, wherein the depth of the well is about 25 microns to about 500 microns.

13. The method of claim 1, wherein the depth of the well is about 100 microns to about 250 microns.

14. The method of claim 1, wherein the depth of the well is about 140 microns to about 180 microns.

15. The method of claim 1, wherein the first volume is less than 2.5 ul.

16. The method of claim 1, wherein the first volume is less than 1 ul.

17. The method of claim 1, wherein the shoulder is present and the height of the shoulder is about one mm or less.

18. The method of claim 1, wherein the shoulder is present and the height of the shoulder is about 650 microns or less.

19. The method of claim 1, wherein the liquid sample is administered manually through multichannel pipettes.

20. The method of claim 1, wherein the liquid sample is administered through an automated liquid handling system.

21. The method of claim 1, wherein the second volume is about 0.5 microliters to about 25 microliters.

22. The method of claim 1, wherein the liquid sample sits in the well in a hemisphere shape.

23. The method of claim 1, wherein the shoulder is present and the distance from the bottom of the well to the top of the liquid sample sitting in the well exceeds the depth of the well plus the height of the shoulder.

24. The method of claim 1, wherein the liquid sample comprises analytes capable of being captured by the reactive site.

25. The method of claim 1, wherein the liquid sample comprises antigens and wherein the reactive sites comprises antibodies.

26. The method of claim 1, wherein the slide is made of glass.

27. The method of claim 1, wherein the slide is a solid piece of epoxy glass.

28. The method of claim 1, wherein the slide is a solid piece of epoxy glass printed with an array of antibodies for reactive sites.

29. The method of claim 1, wherein the reaction site is printed onto the slide via Dip Pen Nanolithography process.

30. The method of claim 1, wherein the reaction site is printed with use of direct write nanolithography.

31. The method of claim 1, wherein the reaction site is printed with use of a stamping process or a non-contact printing process.

32. The method of claim 1, wherein the positions of the reaction site matches the positions of the wells.

33. The method of claim 1, wherein the reaction site comprises at least one capture molecule capable of capturing analytes.

34. The method of claim 1, wherein the bottom surface of the slide is hydrophilic.

35. The method of claim 1, wherein the liquid sample transforms to a cylindrical shape upon contacting the bottom surface of the slide.

36. The method of claim 1, wherein the liquid sample creates a reaction volume over the reactive site upon contacting the bottom surface of the slide.

37. The method of claim 1, wherein the shoulder is present and placement of the slide on the shoulder creates a closed incubation chamber preventing the liquid samples from evaporation and outside contamination.

38. The method of claim 1, further comprising the step of securing the slide to the chip.

39. The method of claim 1, wherein the slide is secured to the chip using a weight or with a screw.

40. The method of claim 1, wherein the method is carried out without use of a gasket.

41. A method comprising
providing a chip comprising a first surface comprising a plurality of wells of a first volume on the first surface;
providing a slide comprising a first surface and at least one array of reactive sites on the first surface;
disposing at least one liquid sample of a second volume into at least one of the wells, wherein the second volume substantially exceeds the first volume, and wherein the liquid sample sits within and above the well;
contacting the liquid sample with the array of reactive site,
wherein a gasket is not used to surround the liquid sample.

42. The method of claim 41, wherein the contacting step is carried out so that the chip and the slide are separated by a predetermined distance.

43. The method of claim 41, wherein the array is printed on the slide by a direct write nanolithographic process.

44. The method of claim 41, wherein the contacting step is carried out so that the chip and the slide are separated by a predetermined distance determined by a height of a shoulder disposed on the chip.

45. The method of claim 41, wherein the number of wells is at least 48 and the number of reaction sites in the array is at least 48.

46. The method of claim 41, wherein the reaction sites are separated from each other in the array by about 10 nm to about 100 microns.

47. The method of claim 41, wherein the second volume is about 0.5 microliters to about 25 microliters.

48. The method of claim 41, wherein the well has an average well depth of about 25 microns to about 500 microns.

49. The method of claim 41, wherein the well has an average well diameter of about 1 mm to about 5 mm.

50. The method of claim 41, wherein the contact results in a compression of the droplet.

51. An article, comprises:
a chip defining a top surface and edges surrounding the top surfaces, having at least one well on the top surface for receiving liquid, and comprising, optionally, a shoulder along the edges and elevated from the top surface;
a slide disposed on the chip and defining a bottom surface and comprising at least one reaction site on the bottom surface aligned opposite of the well.

52. The article of claim 51, wherein the optional shoulder is present, and the slide is detachably placed on the shoulders for contacting and drawing liquid from the well onto the reactive site.

53. The article of claim 51, wherein the chip is made of plastic.

54. The article of claim 51, wherein the chip is a solid piece of plastic of rectangular shape with machined top surface.

55. The article of claim 51, wherein the number of wells is at least 48.

56. The article of claim 51, wherein the wells are disposed on the top surface in an array layout.

57. The article of claim 51, wherein the distance between the wells matches the pitch between the tips of commercially available multichannel pipettes or liquid handling systems.

58. The article of claim 51, wherein the well is of round shape.

59. The article of claim 51, wherein the depth of the well is less than 500 um.

60. The article of claim 51, wherein the depth of the well is less than 300 um.

61. The article of claim 51, wherein the depth of the well is less than 160 um.

62. The article of claim 51, wherein the volume of the well is less than 2.5 ul.

63. The article of claim 51, wherein the volume of the well is less than 1 ul.

64. The article of claim 51, wherein the shoulder is present and the height of the shoulder is no more than 450 um.

65. The article of claim 51, wherein the shoulder is present and the height of the shoulder is no more than 200 um.

66. The article of claim 51, wherein the slide is made of glass.

67. The article of claim 51, wherein the slide is a solid piece of epoxy glass.

68. The article of claim 51, wherein the slide is a solid piece of epoxy glass printed with an array of antibodies to form the reaction sites.

69. The article of claim 51, wherein the reaction site is printed onto the slide via Dip Pen Nanolithography process.

70. The article of claim 51, wherein the position of the reaction site matches the position of the well.

71. The article of claim 51, wherein the reaction site comprises capture molecules capable of capturing one or more analytes.

72. The article of claim 51, wherein the bottom surface of the slide is hydrophilic.

73. The article of claim 51, wherein the placement of the slide on the shoulders create a closed incubation chamber preventing both outside contamination and liquid evaporation.

74. The article of claim 51, further comprising a weight being placed on the slide for securing the slide on the chip.

75. The article of claim 51, further comprising a screw for securing the slide on the chip.

76. An article comprising:
a chip of rectangular shape made of plastic, said chip comprising a top surface being machined, edges surrounding the top surfaces, a plurality of wells on the top surface for receiving liquid, and shoulders along the edges and elevated from the top surface;
a slide made of epoxy glass, said slide comprising a bottom surface of hydrophilic nature and a plurality of capture molecules on the bottom surface;
wherein the depth of the well is no more than 160 um, the volume of the well is no more than 1 ul, the height of the shoulder is no more than 450 um, the number of the wells is selected from the group consisting of 48, 96, 384, and the distance between the wells matches the pitch between the tips of commercially available multichannel pipettes or liquid handling systems;
wherein the capture molecules is printed on the bottom surface via a direct write nanolithography process, the capture molecules are capable of capturing at least one analyte from a liquid sample, and the position of the capture molecules matches the position of the wells; and
wherein the slide is detachably placed on the shoulders, is capable of contacting and drawing liquid from the well onto the capture molecules, and is capable of creating a closed incubation chamber preventing both outside contamination and liquid evaporation.

77. A method comprising
providing a chip comprising a first surface comprising a plurality of wells of a first volume on the first surface;
providing a slide comprising a first surface and at least one array of reactive sites on the first surface;
disposing bulk liquid over the wells, and;
contacting the bulk liquid with the array of reactive sites.
